(19) United States
(12) Patent Application Publication
(10) Pub. No.: US 2026/0195836 A1
(43) Pub. Date: Jul. 9, 2026

(54) METHOD FOR MATCHING USER-CUSTOMIZED EDUCATIONAL CONTENT INSTRUCTOR BASED ON KEYRING-BASED LIVING RADIUS INFORMATION, AND ELECTRONIC DEVICE USING THE SAME

(71) Applicant: ShinHeung Education Corporation, Gyeonggi-do (KR)

(72) Inventors: Geongwon Kim, Gyeonggi-do (KR); Geonhee Song, Incheon (KR); Juyeon Kim, Seoul (KR); Jinyoung Park, Seoul (KR); Hyunwook Ryu, Seoul (KR); Ilkwon Ko, Seoul (KR)

(21) Appl. No.: 19/056,736

(22) Filed: Feb. 19, 2025

(30) Foreign Application Priority Data
Jan. 6, 2025 (KR) 10-2025-0001661

(51) Int. Cl. G06Q 50/20

(52) U.S. Cl. CPC G06Q 50/20

(57) ABSTRACT

According to an embodiment of the present disclosure, a method for providing user-customized educational content based on keyring-based living radius information includes receiving location data of a user from the keyring, calculating the living radius of the user based on the location data, confirming education history data of the user, generating an instructor list corresponding to the education history data based on the calculated living radius, and providing the instructor list to the user.

### CROSS-REFERENCE TO RELATED APPLICATION

This application claims priority to and the benefit of Korean Patent Application No. 10-2025-0001661, filed on Jan. 6, 2025, the disclosure of which is incorporated herein by reference in its entirety.

### BACKGROUND

### Field of the Invention

Embodiments of the present disclosure relate to a method for matching user-customized educational content instructors based on keyring-based living radius information, and an electronic device using the same. More particularly, the present disclosure relates to a system for calculating a living radius of a user by collecting location information using a keyring, recommending customized educational content based on the calculated living radius of the user, and matching an appropriate instructor.

### Description of the Related Art

The existing education system has the problem of reduced learning efficiency as it fails to adequately reflect the individual needs and interests of students. In the typical education system, instructors provide educational content uniformly, allowing users to selectively choose and take the educational content.

Recently, with the development of artificial intelligence, it is possible to construct a two-way communication system that may actively reflect the interests of users. Even in the education system, it is necessary to reflect the interests of users who take the educational content to some extent. Considering this, a more effective learning environment may be provided for users.

### SUMMARY

In areas where educational infrastructure is insufficient, recommending customized educational content to users may be efficient for both instructors and users. In this case, it may be important to identify what interests a user has based on a living radius of a user.

Embodiments of the present disclosure are intended to solve various problems including the above problems, and provide a customized educational content provision environment, which reflects user's needs and interests in educational content, through a personalized database. However, this problem is only an example, and the scope of the present disclosure is not limited thereto.

According to an embodiment of the present invention, a method for providing user-customized educational content based on keyring-based living radius information may include receiving location data of a user from a keyring, calculating a living radius of the user based on the location data, confirming education history data of the user, generating an instructor list corresponding to the education history data based on the calculated living radius, and providing the instructor list to the user.

The receiving of the location data of the user may include collecting the location data of the user from the keyring according to the number of steps of the user holding the keyring or a preset time cycle, and collecting tag data corresponding to the user from the keyring, and the tag data may be a unique ID of the user, and may be collected and transmitted along with the location data of the user while matching the location data of the user.

The calculating of the living radius of the user may include analyzing the location data of the user for a preset range, and calculating the living radius of the user using a residence of the user as a reference, based on the analyzed result.

The calculating of the living radius of the user may include confirming data about a place where the user stays exceeding a preset number of times and a preset period of time within the living radius, and generating interest data of the user based on the data about the place.

The confirming of the education history data may include confirming online actual course taking history data of the user and the interest data of the user.

The generating of the instructor list may include preprocessing educational content data included in a database, feedback data on the educational content, and the education history data of the user, extracting a feature from the preprocessed data, training embedding vectors for the user and the content through matrix factorization, and generating the instructor list through a hybrid model based on the training result.

The hybrid model may have architecture training a nonlinear relationship including a fully connected layer, and perform evaluation using feedback data after the user selects an instructor from the instructor list.

The providing of the instructor list may include confirming education completion data after the user selects an instructor from the instructor list, and updating the instructor list based on feedback data of the user included in the education completion data.

An electronic device for providing customized educational content to a user based on keyring-based living radius information may include a memory, a communication unit, and at least one processor electrically connected to the memory and the communication unit, in which the at least one processor may be configured to receive location data of the user from the keyring, calculate the living radius of the user based on the location data, confirm education history data of the user, generate an instructor list corresponding to the education history data based on the calculated living radius, and provide the instructor list to the user.

According to temporary embodiment of the present disclosure as described above, even in the areas where the educational infrastructure is insufficient, it is possible to recommend the customized educational content based on the living environment of the user. In addition, it is possible to improve the quality of education by matching users with appropriate instructors. It is natural that the scope of the present disclosure is not limited to the above-described effects.

### BRIEF DESCRIPTION OF THE DRAWINGS

FIG. 1 is a block diagram schematically illustrating internal components of an electronic device that provides matching of user-customized educational content instructors according to an exemplary embodiment of the present disclosure.

FIG. 2 is a structural diagram schematically illustrating a method for matching user-customized educational content instructors according to an exemplary embodiment of the present disclosure.

FIG. 3 is an exemplary diagram regarding user-related data collection according to an exemplary embodiment of the present disclosure.

FIG. 4 is a flowchart schematically illustrating a generation of an artificial intelligence (AI) model for matching user-customized educational content instructors according to an exemplary embodiment of the present disclosure, and a prediction process according to the generated AI model.

FIG. 5 is a diagram illustrating a data transmission and reception process required for a method for matching user-customized educational content instructors according to an exemplary embodiment of the present disclosure.

FIG. 6 is a flowchart of an update process of an AI model for matching user-customized educational content instructors according to an exemplary embodiment of the present disclosure.

### DETAILED DESCRIPTION

Since the present disclosure may be variously modified and have several embodiments, specific embodiments will be illustrated in the accompanying drawings and be described in detail in a detailed description. Various advantages and features of the present disclosure and methods accomplishing them will become apparent from the following description of embodiments with reference to the accompanying drawings. However, the present disclosure may be modified in many different forms and it should not be limited to the exemplary embodiments set forth herein.

In the following embodiments, terms such as first, second, etc., are used for the purpose of distinguishing one component from another component, not in a limiting sense.

Singular forms are intended to include plural forms unless the context clearly indicates otherwise.

In the following embodiments, the terms “include,” “have,” or the like means that a feature or element described in the specification is present, and it does not preclude in advance the possibility that one or more other features or components may be added.

In the following embodiments, when a part of a layer, a region, a component, etc. is on or above another part, this includes not only the case where the part is in contact with and directly on another part, but also the case where other regions, other components, etc., are also interposed therebetween.

Sizes of components may be exaggerated or reduced in the accompanying drawings for convenience of explanation. For example, the size and thickness of each component illustrated in the drawings are arbitrarily indicated for convenience of description, and the present disclosure is not necessarily limited to the illustrated those.

In a case where certain embodiments can be otherwise implemented, the order of specific operations may be performed different from the order in which the processes are described. For example, two steps described in succession may be performed substantially simultaneously, or may be performed in an order opposite to the order described.

In this specification, “A and/or B” refers to either A or B, or both A and B. And, “at least one of A and B” indicates that it is A or B or both A and B.

In the following embodiments, when layers, regions, components, etc., are connected, it includes cases where the layers, regions, and components are directly connected, and/or cases where other layers, regions, and components are interposed between the layers, regions, and components and are indirectly connected. For example, in the present specification, when the layers, regions, and components and the like are electrically connected, it includes not only a case where components are directly electrically connected, but also a case where components are indirectly electrically connected via certain component interposed between the components.

An x axis, a y axis, and a z axis are not limited to three axes on an orthogonal coordinate system, but may be interpreted as a broad meaning including the three axes. For example, the x axis, the y axis, and the z axis may be orthogonal to each other or may indicate different directions that are not orthogonal to each other.

Various advantages and features of the present disclosure and methods accomplishing them will become apparent from the following description of embodiments with reference to the accompanying drawings. However, the present disclosure is not limited to embodiments to be described below, but may be implemented in various different forms, these embodiments will be provided only in order to make the present disclosure complete and allow those skilled in the art to completely recognize the scope of the present disclosure, and the present disclosure will be defined by the scope of the claims.

Terms used in the present disclosure are for explaining embodiments rather than limiting the present disclosure. In the present disclosure, unless explicitly described to the contrary, a singular form may also include a plural form. Terms “comprise” and/or “comprising” used in the present disclosure do not exclude the existence or addition of one or more other components other than the mentioned components. Throughout the present disclosure, the same components will be denoted by the same reference numerals, and a term “and/or” includes each and all combinations of one or more of the mentioned components. The terms “first,” “second” and the like are used to describe various components, but these components are not limited by these terms. These terms are used only in order to distinguish one component from other components. Therefore, it goes without saying that the first component mentioned below may be the second component within the technical scope of the present disclosure.

The word “exemplary” is used as the meaning “used as an example or illustration” in the present disclosure. Any embodiment described in the present disclosure as “exemplary” is not necessarily to be construed as preferred or as having advantageous over other embodiments.

Embodiments of the present disclosure may be described in terms of functions or blocks that perform functions. Blocks, which may be referred to as “unit,” “module,” etc., of the present disclosure, may be physically implemented by analog or digital circuits such as logic gates, integrated circuits, microprocessors, microcontrollers, memories, passive electronic components, active electronic components, optical components, and hardwired circuits, and may optionally be driven by firmware and software. In addition, the term “unit” used in the present disclosure means software and hardware elements such as FPGA or ASIC, and the “unit” may perform certain roles. However, the “unit” is not meant to be limited to software or hardware. The “unit” may be configured to be stored in a storage medium that can be addressed or may be configured to regenerate one or more processors. Accordingly, as an example, the “unit” may include elements such as software elements, object-oriented software elements, class elements, and task elements, processes, functions, attributes, procedures, subroutines, segments of program code, drivers, firmware, microcode, circuits, data, databases, data structures, tables, arrays and variables. Functions provided within elements and “units” may be combined into a smaller number of elements and “units” or further separated into additional elements and “units.”

The embodiments of the present disclosure may be implemented using at least one software program running on at least one hardware device and perform network management functions to control elements.

Spatially relative terms “below,” “beneath,” “lower,” “above,” “upper,” and the like, may be used in order to easily describe correlations between one component and other components. The spatially relative terms should be understood as terms including different directions of components during use or operation in addition to the directions illustrated in the drawings. For example, when components illustrated in the drawings are turned up, a component described as “below” or “beneath” another component may be placed “above” another component. Accordingly, an illustrative term “below” may include both of a downward direction and an upward direction. Components may be oriented in other directions as well, and thus, spatially relative terms may be interpreted according to orientations.

Unless defined otherwise, all terms (including technical and scientific terms) used in the present disclosure have the same meanings commonly understood by those skilled in the art to which the present disclosure pertains. In addition, terms defined in generally used dictionaries are not ideally or excessively interpreted unless they are specifically defined clearly.

Hereinafter, the embodiments of the present disclosure will be described in detail with reference to the attached drawings. When describing with reference to the drawings, the same reference numerals will be assigned to identical or corresponding components, and a redundant description thereof will be omitted.

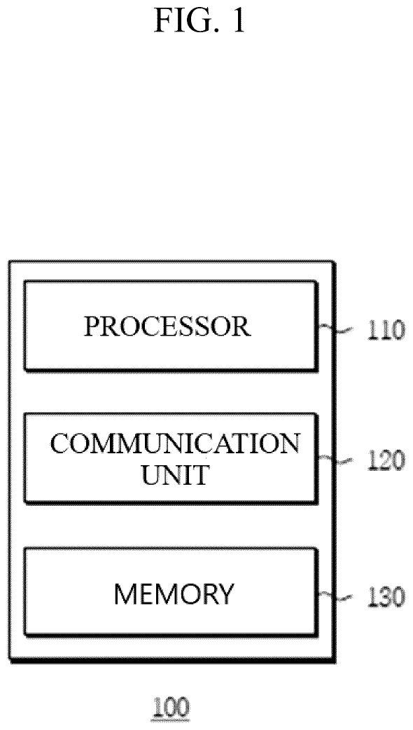

(Embodiment 1) In order to describe Embodiment 1, FIG. 1 is also referred to. The electronic device 100 may include a processor 110, a communication unit 120, a memory 130, etc. Internal components that the electronic device 100 may include are not limited thereto. The electronic device 100 of the present disclosure may perform a function of the processor 110 through a separate processing server or cloud server instead of the processor 110.

The electronic device 100 according to the embodiment may be a type of server, a central processing unit, an application providing server, etc. The server may include a device that provides data to other devices connected to a network through an application or a web. For example, other devices may include devices such as desktops, laptops, tablets, and mobile terminals. As another example, the electronic device 100 may be a device that encompasses an electronic device having specifications capable of performing operations of the present disclosure.

Referring to FIG. 1, the processor 110 may be implemented to perform an operation of matching user-customized educational content instructors using a memory 130 that stores data for an algorithm for controlling operations of components within the electronic device 100 or a program reproducing the algorithm, and the data that is stored in memory 130. In this case, the processor 110 and the memory 130 may be implemented as separate chips. Alternatively, the processor 110 and the memory 130 may be implemented as a single chip.

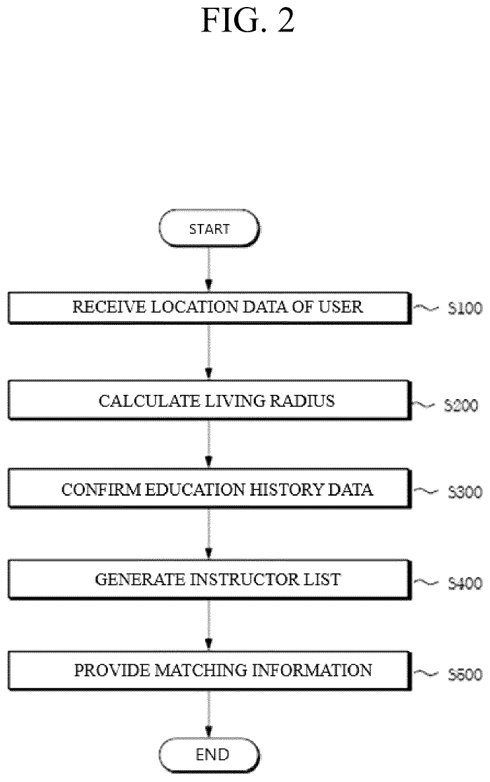

The processor 110 may control one of the components described above or a combination thereof to implement various embodiments according to the present disclosure described in FIGS. 2 to 6 below in the electronic device 100.

The communication unit 120 according to the present embodiment may include one or more components that enable communication with an external device. For example, the communication unit 120 may include at least one of a broadcast reception module, a wired communication module, a wireless communication module, a short-distance communication module, and a location information module.

An input/output interface (not illustrated) according to the embodiment serves as a passage for various types of external devices connected to the electronic device 100 of the present disclosure. The input/output interface unit may include at least one of a wired/wireless headset port, an external charger port, a wired/wireless data port, a memory card port, a port for connection of a device including a subscriber identification module (SIM), an audio input/output (I/O) port, a video input/output (I/O) port, and an earphone port. The electronic device 100 of the present disclosure may perform appropriate control related to an external device connected to the input/output interface.

The memory 130 according to the present embodiment may store data supporting various functions of the electronic device 100, a program for the operation of the processor 110, and input/output data (e.g., images, videos, etc.). The memory 130 may store a plurality of application programs (application programs or applications) running on the electronic device 100, data for the operation of the electronic device 100, and instructions. At least some of these application programs may be downloaded from an external server via a wireless communication.

The memory 130 may include at least one of storage media such as flash memory type, hard disk type, solid state disk type (SSD type), silicon disk drive type (SDD type), multimedia card micro type, and card type memories (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. In addition, the memory 130 may be a database that is separate from the electronic device 100 but is connected by wire or wirelessly.

At least one component may be added or deleted in accordance with the performance of the components illustrated in FIG. 1. In addition, it will be readily understood by those skilled in the art that mutual positions of the components may change in accordance with the performance or structure of the device.

Meanwhile, the disclosed embodiments may be implemented in the form of a recording medium storing instructions executable by a computer. The instructions may be stored in the form of a program code, and may perform operations of the disclosed embodiments by generating program modules when they are executed by a processor. The recording medium may be implemented as a computer-readable recording medium.

The computer-readable recording medium includes all types of recording media in which instructions readable by the computer are stored. Examples of the computer-readable recording medium may include a read only memory (ROM), a random access memory (RAM), a magnetic tape, a magnetic disk, a flash memory, an optical data storage device, and the like.

(Embodiment 2) In order to describe Embodiment 2, FIGS. 1 and 2 are referred to together. The processor 110 according to the embodiment has a function of providing user-customized educational content through the electronic device 100 and providing information on an instructor corresponding to the corresponding educational content. The processor 110 may be separately referred to as a functional block or a processing unit to perform functions of training an artificial intelligence (AI) model and predicting results using the trained AI model. That is, although not physically divided, the processor 110 may include modules referred to as individual function blocks or processing units to perform functions suitable for individual steps.

Referring to FIG. 2, in step S100, the processor 110 may receive location data from a keyring held by a user. The keyring is a type of accessory and may include a GPS module. The keyring may collect the location data of the user through the GPS module. In addition, the keyring may transmit the location data of the user collected through the GPS module to the electronic device 100.

In step S200, the processor 110 may calculate a living radius of a user based on the location data of the user. For example, the living radius may be a radius based on a residence where the user lives with a certain pattern. In addition, the living radius may be set to a preset distance based on an individual user's residence.

The processor 110 according to the embodiment may analyze the location data of the user for a preset range. The preset range may be a range set to calculate the living radius of the user. For example, the preset range may be a range of 5 km radius based on the user's residence. The processor 110 may calculate an actual living radius of a user who lives while moving within the preset range. For example, the processor 110 may specify a location where a user moved farthest from his/her residence within the preset range. When the location where the user moved farthest from his/her residence is 3 km away, the processor 110 may calculate the living radius of the user as 3 km within the preset range (e.g., 5 km radius). As another example, the processor 110 may change and update the existing preset range as it is conformed that the user has moved to a location (e.g., 6 km point) outside the preset range (e.g., 5 km radius), and analyze the location data of the user within the updated preset range (e.g., 7 km radius). Accordingly, the processor 110 may adaptively calculate the living radius of the user based on the result of analyzing the location data of the user within the preset range.

In step S300, the processor 110 may confirm education history data of an individual user who wants to take educational content. The education history data of the user may be stored in the memory 130 or a separate database.

In step S400, the processor 110 may generate an instructor list corresponding to an education history of the individual user based on the living radius. For example, the processor 110 may determine an individual user's interest within the living radius of the individual user. The processor 110 may determine the interest based on a place where the individual user has stayed exceeding a certain number of times and for a certain amount of time. For example, when the user has stayed at a piano lesson academy within the living radius for a preset number of times (e.g., 3 times) and a preset period of time (e.g., 30 minutes/times), the processor 110 may determine the interest of the corresponding user as “piano playing.” Specifically, the processor 110 may confirm that there is “piano composition” in the educational content that the user has previously finished, and further confirm that the interest is “piano playing,” thereby generating an instructor list who provides educational content related to “piano.”

In step S500, the processor 110 may provide the instructor list to match the individual user with the instructors. For example, the processor 110 may confirm a matching score between the individual instructor and the individual user through the data of the instructors included in the instructor list. Accordingly, the processor 110 may preferentially recommend an instructor with a high matching score to a user by reflecting the current user's interests in courses he/she wants to take.

(Embodiment 3) In order to describe Embodiment 3, FIGS. 1 to 3 are referred to together.

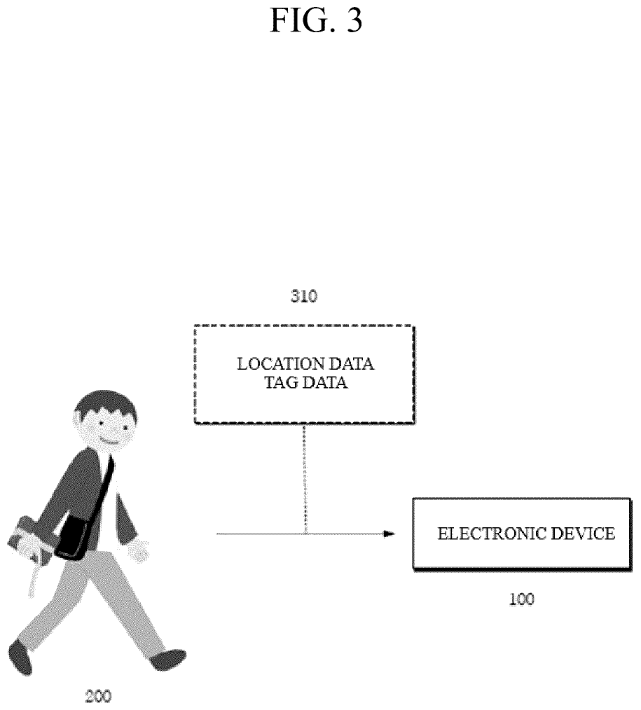

Referring to FIG. 3, a user 200 may move while holding the keyring. Data 310 collected from the user 200 through the keyring may be location data and tag data. In the case of the location data, the GPS module of the keyring may collect the location data of the user 200 according to the number of steps of the user 200 holding the keyring or a preset time cycle. For example, the number of steps of the user 200 is 2 steps, and the keyring may collect and update the location data of the user 200 every time the user 200 takes 2 steps. For example, the keyring may collect and update the location data of the user 200 according to a preset time cycle (e.g., 3 seconds).

The tag data according to the embodiment may be data about a unique ID of the user 200. For example, a first user may be set as a unique ID “user 1” in the memory 130 or a separate database. The processor 110 may match the location data of the user 200 collected through the keyring with the tag data of the corresponding user, and receive the matched location data and tag data together. In this way, the electronic device 100 may construct a customized database for the individual user 200.

(Embodiment 3-1) In order to describe Embodiment 3, FIGS. 1 to 3 are referred to together.

Referring to FIG. 3, the user 200 may freely walk around a residence. As the user 200 moves, the keyring held by the user 200 may collect the location data of the user 200.

The processor 110 according to the embodiment may analyze the location data of the user within the preset range. For example, by confirming that the location where the user 200 has moved farthest within the preset range based on his/her residence, the processor 110 may analyze the location data of the user 200 to calculate the living radius. When the preset range is 7 km and the user 200 has moved to a location that is 5 km away from the residence, the processor 110 may calculate the living radius of the user 200 as 5 km from the residence.

According to an embodiment, the processor 110 may confirm the place where the user 200 has stayed exceeding a preset number of times and a preset period of time. For example, when the user 200 has stayed at a piano lesson academy within the living radius for a preset number of times (e.g., 3 times) and a preset period of time (e.g., 30 minutes/times), the processor 110 may determine the interest of the corresponding user as “piano playing.” In this way, the processor 110 may generate the interest data of the user 200 based on data about a specific place. That is, the processor 110 may map the location data of the user 200 to area-specific or district-specific map information corresponding to publicly available open-source data to confirm a place where the user 200 has visited and stayed for a certain number of times or more and a certain amount of time or longer, thereby identifying the interests of the user.

The processor 110 may confirm online actual course taking history data and interest data of the user 200. The online actual course taking history data may be data stored in the memory 130 or database. For example, the electronic device 100 may include a server that provides educational content or matches instructors who provide the educational content. The processor 110 may confirm the actual course taking history of the user 200 among the educational content and considering the actual course taking history along with the interest to directly or indirectly provide the educational content that the user 200 may be interested in.

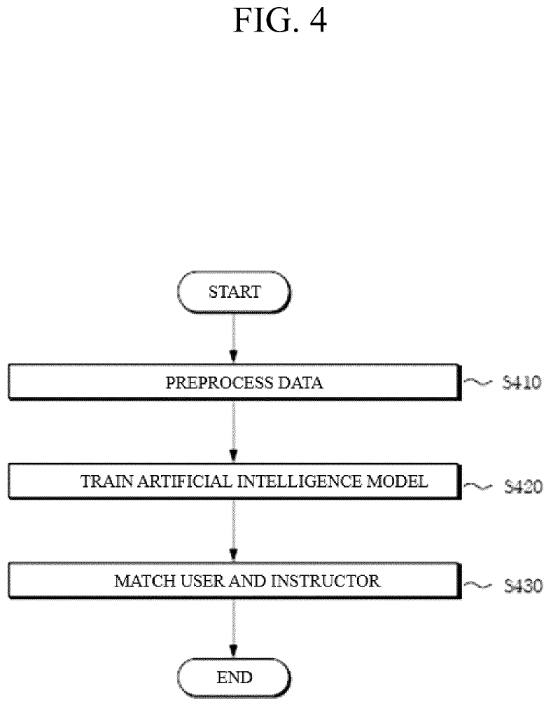

(Embodiment 4) In order to describe Embodiment 4, FIGS. 1 and 4 are referred to together. Embodiment 4 is related to the generation of the AI model for matching the user-customized educational content instructors and the prediction operation according to the generation of the AI model.

Referring to FIG. 4, in step S410, the processor 110 may preprocess data. The data preprocessed by the processor 110 may include educational content data, feedback data for the educational content, and education history data of an individual user. The feedback data may include, for example, reviews, score evaluations, etc., of individual users for the educational content.

According to an embodiment, the processor 110 may collect educational content data, user's feedback data for the educational content, user's education history data, user-related metadata, etc. For example, the educational content data may include a title, a description, a category (e.g., math, science, etc.), difficulty, format (e.g., video, text, etc.), publication date, instructor information, etc., of content. The feedback data may include reviews, evaluation scores, learning completion status, learning time, etc., of a user for content. The user-related metadata may include basic information (e.g., age, gender, etc.), learning history, interests, preferred content types, etc., of a user.

The data preprocessing process may include text preprocessing, feedback score normalization, missing value handling processes, etc. For example, the text preprocessing process may include text data tokenization, stop-word removal, stemming, lemmatization, etc. The feedback score normalization process may contribute to improving the learning efficiency of the model by normalizing continuous data such as user evaluation scores to a range of 0 to 1. The missing value processing process may include a process of filling missing values, etc., by using a mean substitution or a prediction model when there are missing values. In step S420, the processor 110 may perform training to generate the AI

model for providing the user-customized educational content. First, the processor 110 may extract features from each of the preprocessed data. The feature extraction process may include an extraction process for content-based features and an extraction process for user-based features.

According to an embodiment, the extraction process for the content-based features may include a text feature extraction process and a metadata feature extraction process. For example, the text feature extraction process may represent important words of content as vectors based on a description, a title, etc., of content through term frequency-inverse document frequency (TF-IDF). As another example, the text feature extraction process may utilize models such as Word2Vec, GloVe, or BERT through word embedding to convert the description and title of the content into high-dimensional vectors. For categorical features, the metadata feature extraction process may vectorize a category, a format, etc., of content through one-hot encoding or embedding. As another example, for continuous features, the metadata feature extraction process may perform normalization on difficulty, publication date, etc., of content.

The extraction process for the user-based features may include a user profile feature extraction process and a behavior feature extraction process. For example, for the categorical features, the user profile feature extraction process may perform vectorization on interests, preferred content types, etc., of a user through one-hot encoding or embedding. For the continuous features, the user profile feature extraction process may perform normalization on an age, a learning time, etc., of a user. The behavior feature extraction process may represent past interaction data as a matrix using a list of content evaluated by a user and the corresponding evaluation scores (e.g., out of 5, like/dislike, etc.). In addition, for activity frequency, the behavior feature extraction process may extract features such as how often the user consumed content of a specific category, and how long the total learning time was.

The processor 110 may prepare training data based on an interaction between a user and content. For example, the processor 110 may perform labeling based on accuracy. In this case, the label may utilize scores that a user gave to content. For example, when a user gave content 4 points, 4 may be labeled. When converted into a binary classification problem (e.g., like/dislike), the processor 110 may specify labels by setting specific criteria. For example, if the score is 4 points or more, it may be labeled as 1 (positive), and if the score is less than 4 points, it may be labeled as 0 (negative). In addition, the processor 110 may perform binary labeling to predict the probability that a user will consume specific content. For example, if a user has taken content, it may be labeled as 1, and if not, it may be labeled as 0.

The processor 110 according to the embodiment may train embedding vectors for a user and content through matrix factorization. The processor 110 may perform the embedding based on the labeled results. For example, for the embedding for the categorical features, the processor 110 may utilize an embedding layer to convert hundreds of categories into low-dimensional (e.g., 50-dimensional) embedding vectors. For the embedding for the text feature, the processor 110 may utilize a pre-trained model such as Word2Vec, GloVe, or BERT to convert text data into a high-dimensional vector. In addition, the processor 110 may combine the text embedding vector with other features (e.g., metadata, user behavior feature data, etc.) to generate a final input vector.

According to an embodiment, the processor 110 may train the embedding vectors of the user and the content through the matrix factorization based on the interaction data between the user and the content. The processor 110 may generate a unique vector for the user and the content to predict a recommendation score for the content through an inner product of the vectors. In addition, the processor 110 may pass the embedding vectors for the user and the content through a deep neural network to perform training on complex nonlinear relationships. This may be referred to as neural collaborative filtering (NCF).

In training the AI model, the processor 110 may configure a hybrid model that combines content-based embedding and collaborative filtering embedding to perform a final prediction. The neural network architecture at this time may be composed of the deep neural network capable of training the complex nonlinear relationship, including a fully connected layer, dropout, batch normalization, etc. The hybrid model may have architecture capable of training a nonlinear relationship, including the fully connected layer. In addition, the processor 110 may perform an evaluation on the AI model using the evaluation of the educational content (e.g., interaction data, feedback data, etc.) of the user after matching the instructors included in the instructor list.

In order to increase the accuracy of the AI model for providing such user-customized educational content, the processor 110 may evaluate the prediction performance of the AI model using a loss function such as mean squared error (MSE) or cross-entropy loss. Examples of evaluation metrics utilized may include root mean squared error (RMSE), accuracy, precision, recall, AUC-ROC, etc. In addition, the processor 110 may optimize hyperparameters (e.g., the number of embedding dimensions, learning rate, dropout rate, etc.) of the AI model through grid search, random search, etc.

In step S430, the processor 110 may confirm training completion data after selecting instructors from the user's instructor list and update the instructor list based on the feedback data. That is, the processor 110 may provide the instructor list to users to match the users and the instructors, and accept feedback from the users to continuously update the instructor list.

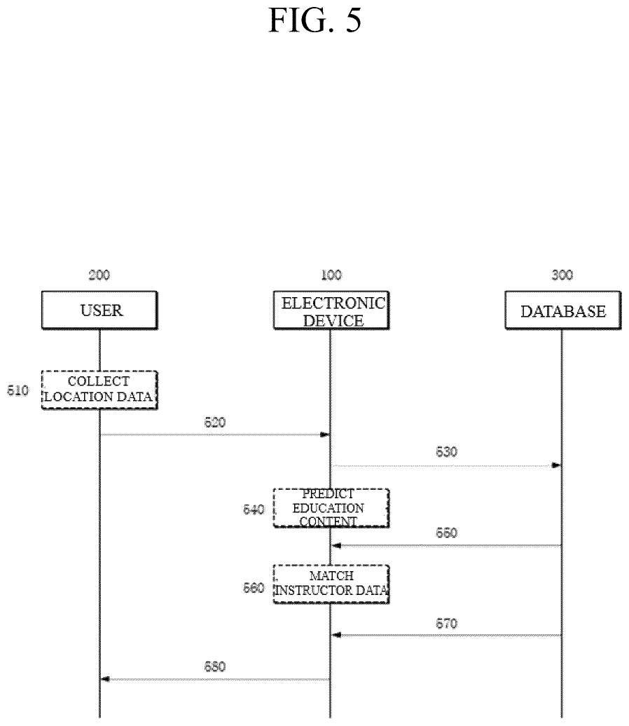

(Embodiment 5) In order to describe Embodiment 5, FIGS. 1 and 5 are referred to together. Embodiment 5 is related to data transmission and reception operations required for a method for matching user-customized educational content instructors.

Referring to FIG. 5, a system for providing user-customized educational content may include the electronic device 100, the user 200, and a database 300. The system of the present disclosure may include an educational business system or an educational matching system that provides educational content or matches instructors for the educational content. In 510, the keyring held by the user 200 may collect the location data of the user 200. A type of preset travel destinations may be confirmed.

In 520, the electronic device 100 may receive the location data of the user 200 through the communication unit 120. In this case, the electronic device 100 may be connected to the keyring through the network to exchange data. Thereafter, in 530 , the electronic device 100 may provide the location data of the user 200 to the database 300. The database 300 may store the received location data of the user 200, and may store and update the location data for each user 200 through the tag data that is collected by matching the location data of the user 200.

In 540, the electronic device 100 may perform prediction on educational content. The prediction on the educational content may involve predicting the educational content that the user needs by reflecting the result of calculating the living radius of the user, the interests of the user, and the education history of the user, etc.

In 550, the database 300 may provide instructor data for educational content provided through the system to the electronic device 100. Thereafter, in 560, the electronic device 100 may match the user and the instructor by considering information on the user and information on the instructor together. That is, the electronic device 100 may generate a list of instructors for educational content that the user is interested in and likely to take to match the user and the instructor. In 570 and 580, the educational content may be provided to the user 200 through the electronic device 100 from the database 300. In this case, since the information on the individual user 200 is stored in the database 300 in the customized manner, the electronic device 100 may provide the customized educational content to the user 200.

(Embodiment 6) In order to describe Embodiment 6, FIGS. 1 to 6 are referred to together.

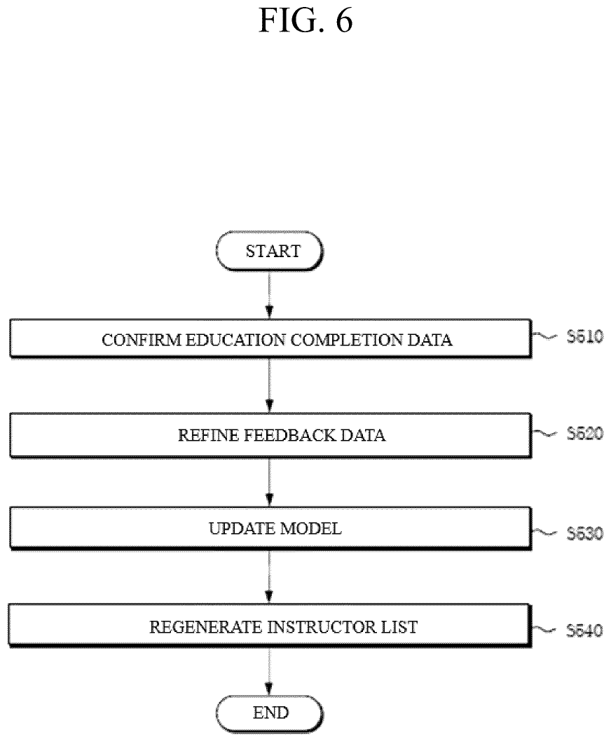

Referring to FIG. 6, in step S510, the processor 110 may confirm user's education completion data after the user and the instructor are matched. The education completion data includes interaction data between the user and the content, and may be, for example, feedback data. That is, the user's education completion data may include feedback data including the evaluation, score, etc., of the user's educational content.

In step S520, the processor 110 may refine the feedback data. This may be that the processor 110 filters and clusters feedback data for individual users. In order to provide the customized educational content to the individual users, it is necessary to refine the feedback data for each individual user.

In step S530, the processor 110 may update the hybrid model. The feedback on the educational content corresponds to a subjective evaluation of individual users, so even for the same educational content, the evaluation may be different. The processor 110 may filter and confirm the feedback data accumulated and stored in the database for each individual user and each individual content. That is, the processor 110 may update the AI model by reflecting the feedback data according to the individual user. In this case, the feedback data for each content may also be utilized.

In step S540, the processor 110 may regenerate the instructor list. Based on the user's feedback data included in the education completion data and the accumulated feedback data for the individual content, the processor 110 may update the instructor list and provide the updated instructor list to the user. In this case, the processor 110 may retrain the AI model based on the feedback, and change the architecture of the AI model or tune the hyperparameters according to the evaluation results to improve its performance, thereby increasing the matching accuracy between the user and the content.

Until now, only the electronic device has been mainly described, but the present disclosure is not limited thereto. For example, a method for manufacturing the electronic device may also fall within the scope of the present disclosure.

Although the present disclosure has been described with reference to exemplary embodiments illustrated in the accompanying drawings, it is only an example. It will be understood by those skilled in the art that various modifications and equivalent other exemplary embodiments are possible from the present disclosure. Accordingly, the true technical protection scope of the present disclosure is to be defined by the following claims.

### DETAILED DESCRIPTION OF MAIN ELEMENTS

100: Electronic device
110: Processor
120: Communication unit
130: Memory

What is claimed is:

1. A method for providing user-customized educational content based on keyring-based living radius information, comprising:
receiving location data of a user from a keyring;
calculating a living radius of the user based on the location data;
confirming education history data of the user;
generating an instructor list corresponding to the education history data based on the calculated living radius; and
providing the instructor list to the user.

2. The method of claim 1, wherein the receiving of the location data of the user includes:
collecting the location data of the user from the keyring according to the number of steps of the user holding the keyring or a preset time cycle; and
collecting tag data corresponding to the user from the keyring,
wherein the tag data is a unique ID of the user, and is collected and transmitted along with the location data of the user while matching the location data of the user.

3. The method of claim 1, wherein the calculating of the living radius of the user includes:
analyzing the location data of the user for a preset range; and
calculating the living radius of the user using a residence of the user as a reference, based on the analyzed result.

4. The method of claim 3, wherein the calculating of the living radius of the user includes:
confirming data about a place where the user stays exceeding a preset number of times and a preset period of time within the living radius; and
generating interest data of the user based on the data about the place.

5. The method of claim 4, wherein the confirming of the education history data includes confirming online actual course taking history data of the user and the interest data of the user.

6. The method of claim 5, wherein the generating of the instructor list includes:
preprocessing educational content data included in a database, feedback data on the educational content, and the education history data of the user;
extracting a feature from the preprocessed data;
training embedding vectors for the user and the content through matrix factorization; and
generating the instructor list through a hybrid model based on the training result.

7. The method of claim 6, wherein the hybrid model has architecture training a nonlinear relationship including a fully connected layer, and performs evaluation using feedback data after the user selects an instructor from the instructor list.

8. The method of claim 1, wherein the providing of the instructor list includes:
confirming education completion data after the user selects an instructor from the instructor list; and
updating the instructor list based on feedback data of the user included in the education completion data.

9. An electronic device for providing customized educational content to a user based on keyring-based living radius information, comprising:
a memory;
a communication unit; and
at least one processor electrically connected to the memory and the communication unit,
wherein the at least one processor is configured to:
receive location data of the user from the keyring,
calculate the living radius of the user based on the location data,
confirm education history data of the user,
generate an instructor list corresponding to the education history data based on the calculated living radius, and
provide the instructor list to the user.

10. A computer-readable storage medium on which a computer program for performing the method of claim 1 is recorded.
